(19) United States
(12) Patent Application Publication
(10) Pub. No.: US 2023/0035002 A1
(43) Pub. Date: Feb. 2, 2023

(54) APPARATUS AND METHOD FOR PARTICLE DEPOSITION DISTRIBUTION ESTIMATION

(71) Applicant: SYMEO GMBH, Neubiberg (DE)

(72) Inventors: Charles MATHY, Arlington, MA (US); Johannes TRAA, Medford, MA (US); Sven RÖHR, Zeuthen (DE); Martin Josef OESTERLEIN, Stockheim (DE)

(21) Appl. No.: 17/874,584

(22) Filed: Jul. 27, 2022

Related U.S. Application Data
(60) Provisional application No. 63/226,055, filed on Jul. 27, 2021.

(51) Int. Cl. B05B 12/08; G01S 13/89; G01S 13/58

(52) U.S. Cl. CPC B05B 12/084; G01S 13/89; G01S 13/584

(57) ABSTRACT

A method collects radar signals reflected from particles distributed by an emission device. A three-dimensional range-angle-velocity cube is formed from the radar signals. The three-dimensional range-angle-velocity cube includes individual bins with radar intensity values characterizing angle and range for a specific velocity. The three-dimensional range-angle-velocity cube is analyzed to identify a ground plane and radar signals reflected from particles immediately proximate to the ground plane. Total particle deposition distribution is predicted.

### CROSS-REFERENCE TO RELATED APPLICATION

This application claims priority to U.S. Provisional Patent Application Ser. No. 63/226,055, filed Jul. 27, 2021, the contents of which are incorporated herein by reference.

### FIELD OF THE DISCLOSURE

The present disclosure relates to estimating particle deposition distribution. More specifically, this disclosure describes techniques, methods, and systems for providing material deposition estimation using Multiple-input multiple-output (MIMO) radar.

### BACKGROUND

A broadcast seeder, alternately called a broadcaster, broadcast spreader or centrifugal fertilizer spreader (Europe), is a farm implement commonly used for spreading seed, lime, fertilizer, sand, ice melt, etc., and is an alternative to drop spreaders/seeders. A large material hopper is positioned over a horizontal spinning disk, the disk has a series of fins attached to it which throw the dropped materials from the hopper out and away from the seeder/spreader.

Alternately, a pendulum spreading mechanism may be employed. This method is more common in mid-sized commercial spreaders for improved consistency in spreading. Some seeders/spreaders have directional fins to control the direction of the material that is thrown from the spreader. Most broadcast spreaders require some form of power to spin the disk. On tow behind units, the wheels spin a shaft that turns gears which, in turn, spin the disk. With tractor mounted units, a mechanical power take-off (P.T.O.) shaft connected to the tractor and controlled by the tractor operator, spins the disk. There are some seeder/spreaders made for garden size tractors that use a 12-volt motor (or any suitable electric motor) to spin the dispersing disk and yaw. Broadcast spreaders can also be used under drones.

Spreaders are machines that have to accurately spread material, e.g., in mining and agriculture. Obtaining a homogeneous spread of material for a machine moving quickly can be challenging for the following reasons. The material may obscure the view. There could be wind, rain, uneven surfaces, and the material may be hard to measure once it lands.

There is a need in the art for uniform spreading. Many techniques that have been proposed rely upon mechanical implementation to achieve a degree of uniformity. The current state of the art has no real time distribution estimate or modeling. The inventors of the present disclosure have identified these shortcomings and recognized a need for the ability to precisely monitor the deposition of material over an area.

### SUMMARY OF THE DISCLOSURE

A method collects radar signals reflected from particles distributed by an emission device. A three-dimensional range-angle-velocity cube is formed from the radar signals. The three-dimensional range-angle-velocity cube includes individual bins with radar intensity values characterizing angle and range for a specific velocity. The three-dimensional range-angle-velocity cube is analyzed to identify a ground plane and radar signals reflected from particles immediately proximate to the ground plane. Total particle deposition distribution is predicted.

### BRIEF DESCRIPTION OF THE DRAWINGS

The present disclosure is best understood from the following detailed description when read with the accompanying figures. It is emphasized that, in accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion.

For a fuller understanding of the nature and advantages of the present invention, reference is made to the following detailed description of preferred embodiments and in connection with the accompanying drawings, in which:

FIG. 1 depicts an exemplary schematic of a particle deposition setup, in accordance with some embodiments of the disclosure;

FIG. 2A depicts an exemplary schematic of a MIMO radar system, in accordance with some embodiments of the disclosure;

FIG. 2B illustrates an exemplary coordinate system schematic surrounding a MIMO radar system, in accordance with some embodiments of the disclosure;

FIG. 3A depicts an exemplary radar cube, in accordance with other embodiments of the disclosure;

FIG. 3B illustrates exemplary coordinates in a bird's eye view of the detection system, in accordance with some embodiments of the disclosure;

FIGS. 4A and 4B illustrate an exemplary schematic of signals coming from a MIMO radar system during particle deposition, in accordance with other embodiments of the disclosure;

FIG. 5 depicts exemplary signals in a radar cube during particle deposition, in accordance with some embodiments of the disclosure;

FIGS. 6A and 6B depict an exemplary estimated deposition distribution, in accordance with some embodiments of the disclosure;

FIG. 7 depicts an exemplary spreading feedback control system, in accordance with some embodiments of the disclosure; and

FIG. 8 illustrates an apparatus configured in accordance with an embodiment of the disclosure.

### DETAILED DESCRIPTION

The present disclosure relates to estimating particle deposition distribution. More specifically, this disclosure describes techniques, methods, and systems providing material deposition estimation using MIMO radar. The ability to precisely monitor the deposition of material over an area has many applications, such as in autonomous agriculture and mining. Examples of materials which are deposited, either by design or as a byproduct, are water, seed, fertilizer, and particulate matter whose monitoring may be desired for environmental reasons.

The following description and drawings set forth certain illustrative implementations of the disclosure in detail, which are indicative of several exemplary ways in which the various principles of the disclosure may be carried out. The illustrative examples, however, are not exhaustive of the many possible embodiments of the disclosure. Other objects, advantages and novel features of the disclosure are set forth in the proceeding in view of the drawings where applicable.

Depending on environment, a plurality of different types of sensors for sensing the surrounding of a vehicle or spreader can be used, such as monoscopic or stereoscopic cameras, light detection and ranging (LiDAR) sensors, and radio detection and ranging (radar) sensors. The different sensor types comprise different characteristics that may be utilized for different tasks.

Radar systems typically provide measurement data, in particular range, doppler, and/or angle measurements (azimuth and/or elevation), with high precision in a radial direction. This allows one to accurately measure (radial) distances as well as (radial) velocities in a field of view of the radar system between different reflection points and the (respective) antenna of the radar system.

Radar systems transmit (emit) radar signals into the radar system's field of view, where the radar signals are reflected off objects that are present in the radar system's field of view. Reflected radar signals are received by the radar system. The transmission signals are, for instance, frequency modulated continuous wave (FMCW) signals. Radial distances can be measured by utilizing the time-of-travel of the radar signal. Radial velocities are measured utilizing the frequency shift caused by the doppler effect.

By repeating the transmitting and receiving of the radar signals, radar systems can observe the radar system's field of view over time by providing measurement data comprising consecutive radar frames.

An individual radar frame may for instance be a range-azimuth-frame or a range-doppler-azimuth-frame. A range-doppler-azimuth-elevation-frame may also be used if data in the elevation-direction is available.

In each of the multiple radar frames, a plurality of reflection points which may form clouds of reflection points can be detected. However, the reflection points or point clouds, respectively, in the radar frames do not contain a semantic meaning per se. Accordingly, a semantic segmentation of the radar frames is sometimes necessary to evaluate (“understand”) the scene of the control system spreader's surrounding.

The segmentation of a radar frame means that the single reflection points in the individual radar frames are assigned a meaning. For instance, reflection points may be assigned to the background of the scene, foreground of the scene, stationary objects such as buildings, walls, parking vehicles or parts of a road, and/or moving objects such as other vehicles, cyclists and/or pedestrians in the scene.

Generally, radar systems observe specular reflections of the transmission signals that are emitted from the radar system, since the objects to be sensed tend to comprise smoother reflection characteristics than the (modulated) wavelengths of the transmission signals. Consequently, the obtained radar frames do not contain continuous regions representing single objects, but rather single prominent reflection points, distributed over regions of the radar frame.

Radar data form a 3-dimensional, complex-valued array (a.k.a. radar cube) with dimensions corresponding to azimuth (angle), radial velocity (doppler), and radial distance (range). Taking the magnitude in each angle-doppler-range bin describes how much energy the radar sensor sees coming from that point in space (angle and range) for that radial velocity.

Obtaining a precise map of the amount of matter deposited as a function of the position on the ground may be challenging for many reasons. Once the material lands on the ground, it may be indistinguishable from the ground. As matter lands on previously landed matter, it obscures itself, making it challenging to quantify the total amount of material.

New material may compact previous material, changing its density and making a simple height estimate unreliable. As the material is being deposited, it may generate a cloud that makes monitoring of the material impossible with a conventional camera, or a laser-based system such as LIDAR.

If a machine is used that is supposed to spread the material evenly, external factors such as wind, rain and unevenness of the surface may lead to the need for continuous adaptation of the amount of material emitted, which in turn requires continuous real-time monitoring of the amount of material deposited.

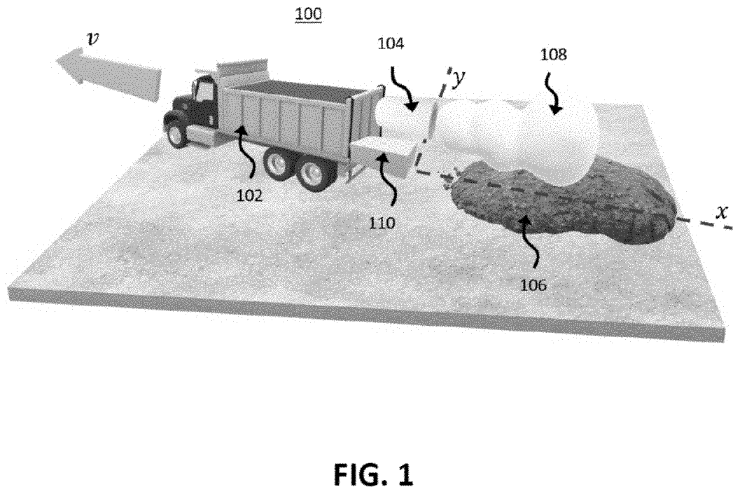

FIG. 1 shows a schematic 100 of a particle deposition setup. A vehicle 102 moves at velocity v. In this example, the vehicle 102 is a truck, but it may also be a drone, farming or mining equipment, and the like. The vehicle 102 emits material through an emission device 104, which deposits material 106. As the material is emitted, it may create a cloud 108 that would make monitoring with a regular camera impossible. A measuring device 110 or multiple devices are tasked with measuring the distribution of material deposited.

Modern Multiple-Input Multiple-Output (MIMO) radar systems offer a promising device to solve the particle deposition estimation problem, since radar penetrates through dust and more generally materials that are opaque to visible light (depending on the frequency), it could see through any cloud of matter (such as dust or water vapor) generated during the depositing of material. MIMO radars use multiple antennas from which one can obtain spatial resolution.

The present disclosure generally relates to Millimeter Wave Sensing, while other wavelengths and applications are not beyond the scope of the disclosure. Specifically, the present method pertains to a sensing technology called Frequency-Modulated Continuous Wave (FMCW) RADAR, which is very popular in automotive and industrial segments.

FMCW radar measures the range, velocity, and angle (azimuth and elevation) of arrival of objects in front of it. At the heart of an FMCW radar is a signal called a chirp. A chirp is a sinusoid or a sine wave whose frequency increases (or decreases) linearly with time. A chirp starts as a sine wave with a frequency of fc and gradually increase its frequency ending up with a frequency of fc plus B, where B is the bandwidth of the chirp. The frequency of the chirp increases linearly with time, linear being the operative word. So, in an f-t plot, the chirp would be a straight line with a slope S, where S=B/T and T is the chirp duration.

Thus, the chirp is a continuous wave whose frequency is linearly modulated. Hence the term frequency-modulated continuous wave or FMCW for short. In one or more embodiments, the radar operates as follows. A synthesizer generates a chirp. This chirp is transmitted by the TX antenna. The chirp is then reflected off of objects, such as, seed. The reflected chirp can then be received at the RX antenna. The RX signal and the TX signal are mixed at a mixer.

The resultant signal is called an intermediate (IF) signal. The IF signal is prepared for signal processing by low-pass (LP) filtering and is sampled using an analog to digital converter (ADC). The significance of the mixer will now be described in greater in detail.

In one or more embodiments, this difference is estimated using a mixer. A mixer has two inputs and one output, as is known in the art. If two sinusoids are input to the two input ports of the mixer, the output of the mixer is also a sinusoid as described below.

The instantaneous frequency of the output equals the difference of the instantaneous frequencies of the two input sinusoids. So, the frequency of the output at any point in time is equal to the difference between the input frequencies of two time-varying sinusoids at that point in time. Tau, t, represents the round-trip delay from the radar to the object and back in time. It can also be expressed as twice the distance to the object divided by the speed of light, ignoring dispersion (dependency on the frequency of the signals). A single object in front of the radar produces an IF signal with a constant frequency given by S2d/c.

To determine range(s), a range-FFT (Fast Fourier Transform) is performed on sampled rows. An FFT is an algorithm that computes the discrete Fourier transform (DFT) of a sequence, or its inverse (IDFT). Fourier analysis converts a signal from its original domain (often time or space) to a representation in the frequency domain and vice versa.

The application of the range-FFT resolves objects in range. As one skilled in the art can appreciate, the x-axis is actually the frequency corresponding to the range FFT bins. But, since range is proportional to the IF frequency, this can be plotted directly as the range axis. The result is a matrix of chirps with each chirp having an array of frequency bins. Pursuant to the discussion above, these bins correspond directly to the range via the IF.

Angle estimation requires at least 2 receiver (RX) antennas. The differential distance of the object to each of these antennas is exploited to estimate distance. So, the transmit (TX) antenna transmits a signal that is a chirp. It is reflected off the object with one ray going from the object to the first RX antenna and another ray going from the object to the second RX antenna.

As an example, a ray to the second RX antenna travels a little longer. That is, an additional distance of delta d. This additional distance results in an additional phase of omega equal to 2 pi delta d by lambda. This is the phase difference between the signal at the first antenna and the signal at the second antenna.

Once the samples have been organized, a three-dimensional FFT is performed on range, angle and velocity. The result is a 3-d radar cube. The radar cube comprises radar intensity as a function of range, angle and velocity. In some embodiments, radar intensity is the energy associated with that time-space location. In another embodiment, radar intensity can also comprise phase information. The cube is segmented in bins. Each bin contains a radar intensity value.

Employing schemes such as Frequency-modulated continuous wave (FMCW), one can resolve the distance and velocity of objects in the scene. What is obtained for such schemes is sometimes called the radar cube, as the system outputs measured radar signal in three dimensions: range, angle, and velocity. For each range, angle and velocity bin, a FMCW MIMO radar system may output an amplitude and phase.

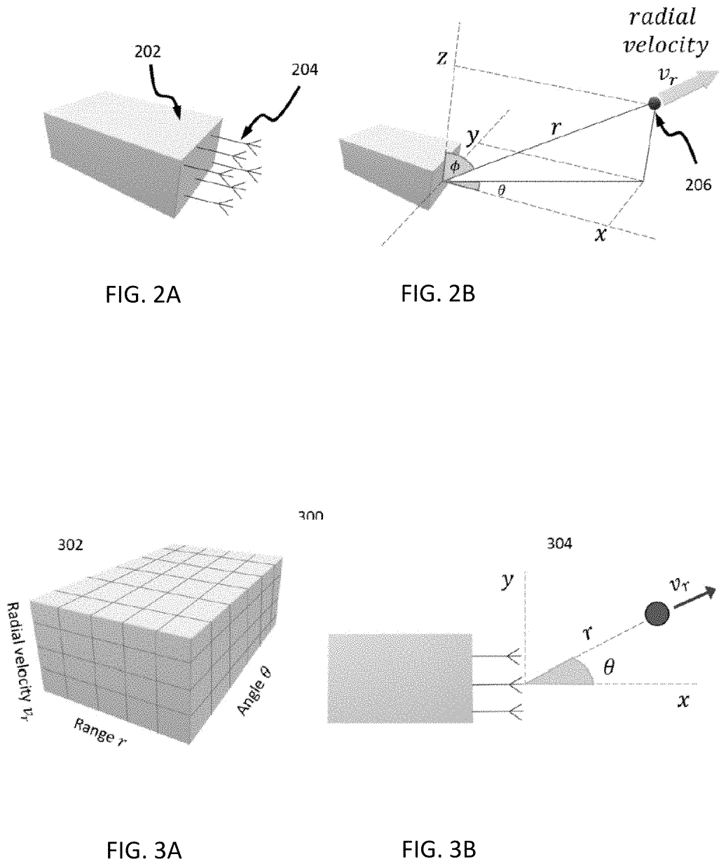

FIG. 2A depicts an exemplary schematic of a MIMO radar system, in accordance with some embodiments of the disclosure. A MIMO radar system 202 is made up of multiple antennae 204, used to obtain range, angle and velocity resolution.

FIG. 2B illustrates an exemplary coordinate system schematic surrounding a MIMO radar system. One may choose a coordinate system where the x axis is pointing outward from the system, the y axis is pointing to the left from the point of view of an observer looking out from the system, and the z axis is pointing upwards. The angle ϕ is measured with respect to the z axis. The angle 90⁰-ϕ) is commonly referred to as the elevation angle.

A combination of processing from a particular configuration of antennae and encasing of the system may reduce the angles ϕ from which the system receives a signal. For example, the objects from which the system receives a signal may be restricted to be at positions whose angle ϕ are near π/2, or equivalently such that the elevation angle is small.

A single MIMO radar system may be able to resolve the radial velocity vᵣ of objects, which is the velocity pointing outwards with respect to the system. It may also use the signal from multiple antennae to resolve the azimuthal angle θ. One could deploy two MIMO radar systems in different locations, so that each system outputs a radial velocity with respect to its position, from which one can resolve more coordinates of the velocity vector. Coherent processing of data from multiple radars could be performed from cooperating radars.

FIG. 3A depicts an exemplary radar cube and FIG. 3B illustrates exemplary corresponding coordinates in a bird's eye view of the detection system. If the angle ϕ is restricted to be near π/2, the system may be approximated to receive data from a two-dimensional plane. FIG. 3A depicts a radar cube 302, which is populated with amplitudes and phases for values of range r, azimuthal angle θ, and radial velocity fiᵣ. A coordinate system 304 of x and y coordinates may be defined such that for an object with range r, angle θ, the coordinates are defined as:

x=r cos(θ)

y=r sin(θ)

The radial velocity is defined as the change in the radial distance over time:

$${v}_{r} = \frac{d}{dt} r .$$

FIG. 3B is a bird's eye view of the coordinate system around the detection device. The x axis points outwards, and y axis points up from the bird's eye view. The angle θ is measured with respect to the x axis. Using multiple antennae, a MIMO radar may resolve the angle θ, giving a set of radar bins. Using a measurement scheme such as an FMCW scheme, it may also resolve range and radial velocity.

During the detection step, a set of points or point clouds are generated. From these, a threshold value can be determined. In other embodiments, the threshold value is already predetermined.

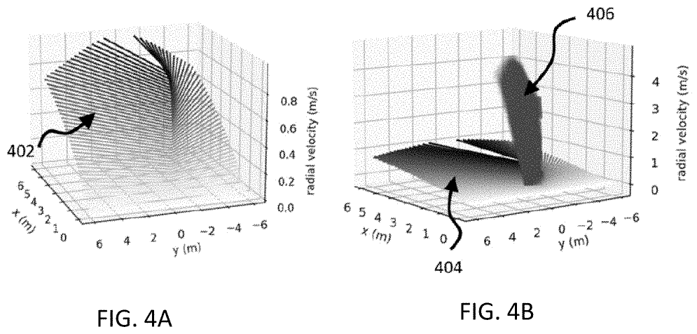

FIGS. 4A and 4B illustrate an exemplary schematic of signals coming from a MIMO radar system during particle deposition, in accordance with other embodiments.

One processing step applied to a radar cube is Constant False Alarm Rate (CFAR) thresholding.

Constant False Alarm Rate (CFAR) thresholding involves estimating a background model through local averaging. CFAR detection refers to a common form of adaptive algorithm used in radar systems to detect target returns against a background of noise, clutter and interference.

The primary idea is that noise statistics may be non-uniform across the array. CA-CFAR (cell averaging) computes a moving mean while excluding a region at the center of the averaging window (guard cells) to avoid including a desired object in the background estimate. OS-CFAR (order-statistic) does the same computation but with a percentile operation instead of a mean.

In some embodiments CFAR is used for detection, however other schemes, such as, cell averaging (CA-CFAR), greatest-of CFAR (GO-CFAR) and least-of CFAR (LO-CFAR) or other suitable means may be used in embodiments of the disclosed technology.

Specifically, in one or more embodiments, the maximum amplitude of the radar signal as a function of velocity is computed, for a given range and angle. This yields an intensity as a function of range and angle, and a velocity corresponding to the largest amplitude. For the problem of particle deposition estimation, this approach may fail.

FIGS. 4A and 4B show an example of radar cube measurement where CFAR thresholding may fail. The measurements of a radar cube can be translated to a x, y, vᵣ coordinate system using the above equations. The radar cube amplitude may have a set of points 402 that correspond to the ground. The ground is typically dense and may give a much stronger signal than the signal obtained from the material 406 that is being deposited. In such cases, CFAR would only return the ground signal, completely obscuring the material being deposited.

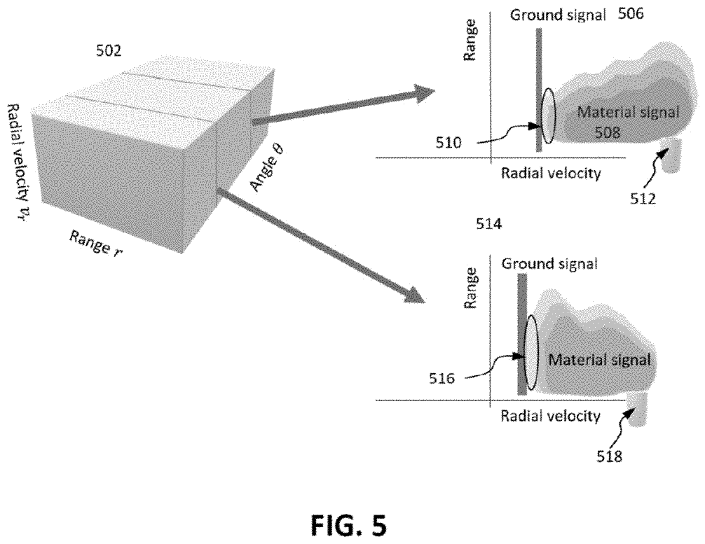

FIG. 5 depicts sketches of measurements in parts of the radar cube 502 during particle deposition. For a given angle θ the measurements in the radar cube may show a strong signal from the ground 506.

If CFAR is applied, the maximum is taken along the velocity direction, and the signal coming from the ground may dominate. The deposited material signal 508 may then not feature in the CFAR threshold signal. For a different angle θ the measurements 506 may show qualitatively the same features. The ground signal may show up at a different velocity. Namely if the vehicle is moving at a velocity v_{vehicle}, then from the perspective of the vehicle, the ground at an angle θ has a radial velocity:

v_{r,ground}=−V_{vehicle} COS(θ)

if radar is looking strictly backwards (x in parallel with moving direction and parallel to the ground).

To obtain the distribution of material deposited on the ground, one approach is to measure the material just as it hits the ground 510 and 516. Namely, if the density of the cloud of material is estimated, as time goes on the material will move, and if one adds the density of the cloud of material from frame to frame, one may double count some of the material. However, the material that is hitting the ground cannot be double counted, as it lands on the ground and becomes indistinguishable from the ground signal. Therefore, we can quantify the amount of material hitting the ground by looking at the signal around the ground signal in the radar cube.

The amplitudes in the radar cube at a given range and angle are proportional to the density of material at that range and angle. That density of material will land on the ground near the given range and angle with respect to the vehicle in the coordinate frame of the radar system. Therefore, one approach is to discretize x-y space 602, and for each square in the grid sum all the material estimated to have been deposited in that square. By making the discretization small enough, and/or combining with smoothing, one can obtain a continuous map of the deposited material 604.

While the present embodiment relates to discretizing one or more dimensions associated with the radar cube, other more continuous techniques, such as, smoothing functions and other density estimations are not beyond the scope of the present disclosure. In probability and statistics, density estimation is the construction of an estimate, based on observed data, of an unobservable underlying probability density function. The unobservable density function is thought of as the density according to which a large population is distributed; the data are usually thought of as a random sample from that population.

A variety of approaches to density estimation are used, including Parzen windows and a range of data clustering techniques, including vector quantization. The most basic form of density estimation is a rescaled histogram.

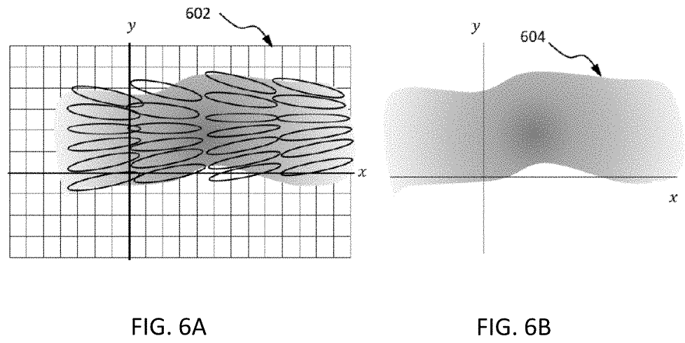

FIGS. 6A and 6B depicts an exemplary estimated deposition distribution, in accordance with some embodiments of the disclosure. The measurements over time of material that is landing on the ground can be combined to form a density map of the deposited material. The estimates of density of material hitting the ground can be combined to form a 2D map 604 of particle deposition distribution.

Also, if the emitter or emission point of deposited material falls within the field of view of the radar, one can also measure the material coming out of the emitter (512, 518). Knowing the amount of emitted material may allow feedback to the emitter. If for example the emitter is depositing too much material, for a given desired deposition, the measurement of emitted material may be fed back to modify the amount of material emitted.

While the present embodiment describes capturing the material estimation just before it hits the ground, other timeframes are not beyond the scope of the present disclosure. Specifically, the radar could estimate the distribution just as the material leaves the spreader. With this, parabolic trajectories could estimate ground distribution while making wind adjustments. Alternatively, estimating both could prove valuable from a conservation of material analysis. A loss of material could represent material falling outside the estimated ground window 604.

A plurality of MIMOs also has the advantage of deterring more precise tangential velocities. This is useful when particulate materials travel at different speeds. At lower speeds, the system runs the risk of double counting the materials. Multiple radars can better estimate the flux of the material traveling though the ground window 604 in addition to estimating lost material.

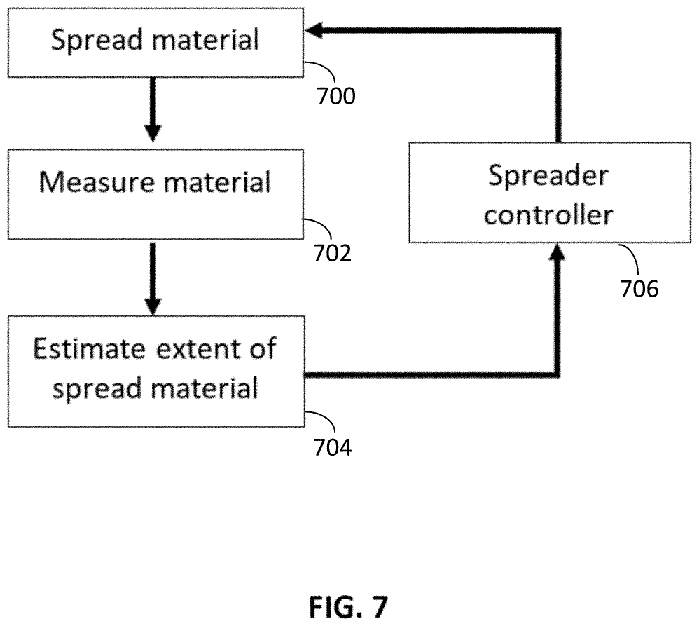

FIG. 7 shows a possible use of the density distribution estimation system in a real-time feedback control system. Material is spread 700, for example, with emission device 104. Material is measured 702 using the techniques disclosed herein. An estimate of the spread material is formed 704. The estimate is used by a spreader controller 706 to modulate the spread of material. The spreader controller modulates the output of the emission device 104.

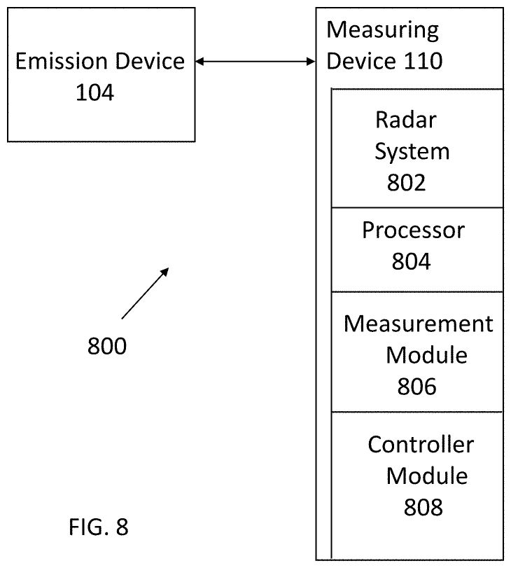

FIG. 8 illustrates an apparatus 800 configured in accordance with an embodiment of the disclosure. The apparatus 800 includes an emission device 104 and a measuring device 110, previously shown in FIG. 1. In this embodiment, the measuring device 110 includes a radar system 802, which may be any radar system discussed herein. A processor 804 executes instructions stored in memory. In this case, the instructions include a measurement module 806 to implement the measurement operations discussed above. A controller module 808 implements the feedback loop of FIG. 7, namely the estimate of the spread material and the generation of control signals for the spreader or emission device 104.

While the present disclosure focuses on MIMO designs, other radars systems are not beyond the inventors perceived scope, such as, Bistatic radar, Continuous-wave radar, Doppler radar, Fm-cw radar, Monopulse radar, Passive radar, Planar array radar, Pulse-doppler, Synthetic aperture radar, Synthetically thinned aperture radar, and Over-the-horizon radar with Chirp transmitter. Similarly, other single, dual and quad modules can be used, as well as any other suitable frequencies.

Also, entirely different sweep signal systems are not beyond the scope of the present invention. For example, any suitable sweep signal system can be employed, such as, sonar, radar, laser systems, LIDAR, spread-spectrum communications, frequency modulated waveform (LFMW) and surface acoustic wave (SAW).

The above description of illustrated embodiments are not intended to be exhaustive or limiting as to the precise forms disclosed. While specific implementations of, and examples for, various embodiments or concepts are described herein for illustrative purposes, various equivalent modifications may be possible, as those skilled in the relevant art will recognize. These modifications may be made in light of the above detailed description, the Abstract, the Figures, or the claims.

Various inventive concepts may be embodied as a computer readable storage medium (or multiple computer readable storage media) (e.g., a computer memory, optical discs, magnetic tapes, flash memories, circuit configurations in Field Programmable Gate Arrays or other semiconductor devices, or other tangible computer storage medium) encoded with one or more programs that, when executed on one or more computers or other processors, perform methods that implement one or more of the various embodiments described above.

In some cases, the teachings of the present disclosure may be encoded into one or more tangible, non-transitory computer-readable mediums having stored thereon executable instructions that, when executed, instruct a programmable device (such as a processor or DSP) to perform the methods or functions disclosed herein. In cases where the teachings herein are embodied at least partly in a hardware device (such as an ASIC, IP block, or SoC), a non-transitory medium could include a hardware device hardware-programmed with logic to perform the methods or functions disclosed herein. The teachings could also be practiced in the form of Register Transfer Level (RTL) or other hardware description language such as VHDL or Verilog, which can be used to program a fabrication process to produce the hardware elements disclosed.

In example implementations, at least some portions of the processing activities outlined herein may also be implemented in software. In some embodiments, one or more of these features may be implemented in hardware provided external to the elements of the disclosed figures or consolidated in any appropriate manner to achieve the intended functionality. The various components may include software (or reciprocating software) that can coordinate in order to achieve the operations as outlined herein. In still other embodiments, these elements may include any suitable algorithms, hardware, software, components, modules, interfaces, or objects that facilitate the operations thereof.

Any suitably-configured processor component can execute any type of instructions associated with the data to achieve the operations detailed herein. Any processor disclosed herein could transform an element or an article (for example, data) from one state or thing to another state or thing. In another example, some activities outlined herein may be implemented with fixed logic or programmable logic (for example, software and/or computer instructions executed by a processor) and the elements identified herein could be some type of a programmable processor, programmable digital logic (for example, an FPGA, an erasable programmable read only memory (EPROM), an electrically erasable programmable read only memory (EEPROM)), an ASIC that includes digital logic, software, code, electronic instructions, flash memory, optical disks, CD-ROMs, DVD ROMs, magnetic or optical cards, other types of machine-readable mediums suitable for storing electronic instructions, or any suitable combination thereof.

1. A method, comprising:
collect radar signals reflected from particles distributed by an emission device;
form a three-dimensional range-angle-velocity cube from the radar signals, the three-dimensional range-angle-velocity cube including individual bins with radar intensity values characterizing angle and range for a specific velocity;
analyze the three-dimensional range-angle-velocity cube to identify a ground plane and radar signals reflected from particles immediately proximate to the ground plane; and
estimate total particle deposition distribution.

2. The method of claim 1 further comprising generating a control signal for the emission device based upon the total particle deposition.

3. The method of claim 1 wherein the operation to collect is implemented with a Multiple-input multiple-output (MIMO) radar.

4. The method of claim 1 wherein the operation to collect is implemented with a Frequency-Modulated Continuous Wave (FMCW) radar signal.

5. The method of claim 1 further comprising forming a density map of deposited particles.

6. The method of claim 1 further comprising analyzing the three-dimensional range-angle-velocity cube to establish ranges of particles.

7. The method of claim 1 further comprising analyzing the three-dimensional range-angle-velocity cube to establish angles of particles.

8. The method of claim 1 further comprising analyzing the three-dimensional range-angle-velocity cube to establish velocities of particles.

9. The method of claim 1 wherein the estimate of total particle deposition distribution is formed with adaptive processing.

10. The method of claim 9 wherein the adaptive processing is constant false alarm rate.

11. The method of claim 9 wherein the adaptive processing excludes any material on the ground and the ground plane.

12. The method of claim 1 further comprising constructing a density cloud of the distribution of the particles.

13. The method of claim 12 wherein the density cloud is two-dimensional.

14. The method of claim 12 wherein the density cloud is three-dimensional.

15. The method of claim 12 wherein the density cloud is constructed by frames derived from the three-dimensional range-angle-velocity cube.

16. The method of claim 1 further comprising measuring material coming out of the emission device.

17. The method of claim 16 further comprising modifying the amount of material coming out of the emission device.
